(19) United States
(12) Patent Application Publication
(10) Pub. No.: US 2025/0106824 A1
(43) Pub. Date: Mar. 27, 2025

(54) DIFFERENTIAL USER EQUIPMENT (UE) CROSS-LINK INTERFERENCE (CLI) REPORT

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US); Huilin XU, Temecula, CA (US); Yuwei REN, Beijing (CN); Navid ABEDINI, Basking Ridge, NJ (US); Junyi LI, Greentown, PA (US)

(21) Appl. No.: 18/728,844

(22) PCT Filed: Mar. 16, 2022
(86) PCT No.: PCT/CN2022/081141

§ 371 Date: Jul. 12, 2024

(51) Int. Cl. H04W 72/04; H04W 24/10

(52) U.S. Cl. CPC H04W 72/04; H04W 24/10

(57) ABSTRACT

A method of wireless communication by a first user equipment (UE), includes receiving downlink signals from a network device. The method also includes receiving cross-link interference (CLI) to the downlink signals, the cross-link interference originating from a second UE. The method further includes receiving a configuration for a report of multiple differential cross-link interference metric values measured for multiple different cross-link interference resources and an absolute cross-link interference metric value measured for the different CLI resources. The method includes transmitting the report of the differential cross-link interference metric values measured for the different CLI resources.

### FIELD OF THE DISCLOSURE

The present disclosure relates generally to wireless communications, and more specifically to differential inter-user equipment (UE) cross-link interference (CLI) report.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)—Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by a first user equipment (UE), includes receiving downlink signals from a network device. The method also includes receiving cross-link interference (CLI) to the downlink signals, the cross-link interference originating from a second UE. The method further includes receiving a configuration for a report of multiple differential cross-link interference metric values measured for multiple different cross-link interference resources and an absolute cross-link interference metric value measured for the different CLI resources. The method also includes transmitting the report of the differential cross-link interference metric values measured for the different CLI resources.

In aspects of the present disclosure, a method of wireless communication by a network device, includes transmitting downlink signals to a first user equipment (UE). The method also includes configuring the first UE with multiple cross-link interference (CLI) resources. The method further includes configuring the first UE with a report of multiple differential cross-link interference metric values measured for multiple different cross-link interference resources and an absolute cross-link interference metric value measured for the different CLI resources. The method includes receiving, from the first UE, the report of the differential cross-link interference metric values measured for the CLI resources.

Other aspects of the present disclosure are directed to an apparatus for wireless communication by a first user equipment (UE). The apparatus has a memory and one or more processor(s) coupled to the memory. The processor(s) is configured to receive downlink signals from a network device. The processor(s) is also configured to process cross-link interference (CLI) to the downlink signals, the cross-link interference originating from a second UE. The processor(s) is further configured to receive a configuration for a report of multiple differential cross-link interference metric values measured for multiple different cross link-interference resources and an absolute cross-link interference metric value measured for the different CLI resources. The processor(s) is also configured to transmit the report of the differential cross-link interference metric values measured for the different CLI resources.

Other aspects of the present disclosure are directed to an apparatus for wireless communication by a network device. The apparatus has a memory and one or more processor(s) coupled to the memory. The processor(s) is configured to transmit downlink signals to a first user equipment (UE). The processor(s) is also configured to configure the first UE with multiple cross-link interference (CLI) resources. The processor(s) is further configured to configure the first UE with a report of multiple differential cross-link interference metric values measured for multiple different cross- link interference resources and an absolute cross-link interference metric value measured for the different CLI resources. The processor(s) is also configured to receive, from the first UE, the report of the differential cross-link interference metric values measured for the CLI resources.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture.

FIG. 4 is a block diagram illustrating a first example full duplex use case, in accordance with aspects of the present disclosure.

FIG. 5 is a block diagram illustrating a second example full duplex use case, in accordance with aspects of the present disclosure.

FIG. 6 is a block diagram illustrating a third example full duplex use case, in accordance with aspects of the present disclosure.

FIG. 7 is a block diagram illustrating an example deployment scenario, in accordance with aspects of the present disclosure.

FIG. 8 is a block diagram illustrating an example cross-link interference report, in accordance with aspects of the present disclosure.

FIG. 9 is a flow diagram illustrating an example process performed, for example, by a user equipment (UE), in accordance with various aspects of the present disclosure.

FIG. 10 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Currently, devices generally communicate in a half-duplex mode where the devices either transmit a signal or receive a signal at one time. Full duplex communication allows simultaneous transmission and reception. Thus, full duplex communication has the potential to increase throughput for both a base station and a user equipment (UE).

In 3GPP Release 16, for inter-UE cross-link interference reporting, one cross-link interference metric is reported for each cross-link interference resource. In the case of full duplex frequency division multiplexed (FDM) communications from a base station, cross-link interference leaking from uplink bandwidth (BW) can vary across downlink subbands (SB). Separate cross-link interference resources may need to be configured for each downlink subband to measure the leaked cross-link interference. Cross-link interference has various levels of impact from subband to subband. A differential or delta cross-link interference report across subbands may be used to reduce report overhead. Cross-link interference may also have various levels of impact from cross-link interference resource to cross-link interference resource in the time domain. In other words, the interference may vary at different times. In this case, a differential or delta cross-link interference report across different cross-link interference time resources may be used to reduce report overhead as well.

According to aspects of the present disclosure, a UE may report differential cross-link interference metric values. The reporting may be based on a configuration received from a base station. In some aspects, the UE measures the values on different subbands. In other aspects, the UE measures the values on different cross-link interference time resources. A wideband cross-link interference resource can be configured for multiple subbands, or individual cross-link interference resources may be configured for each subband.

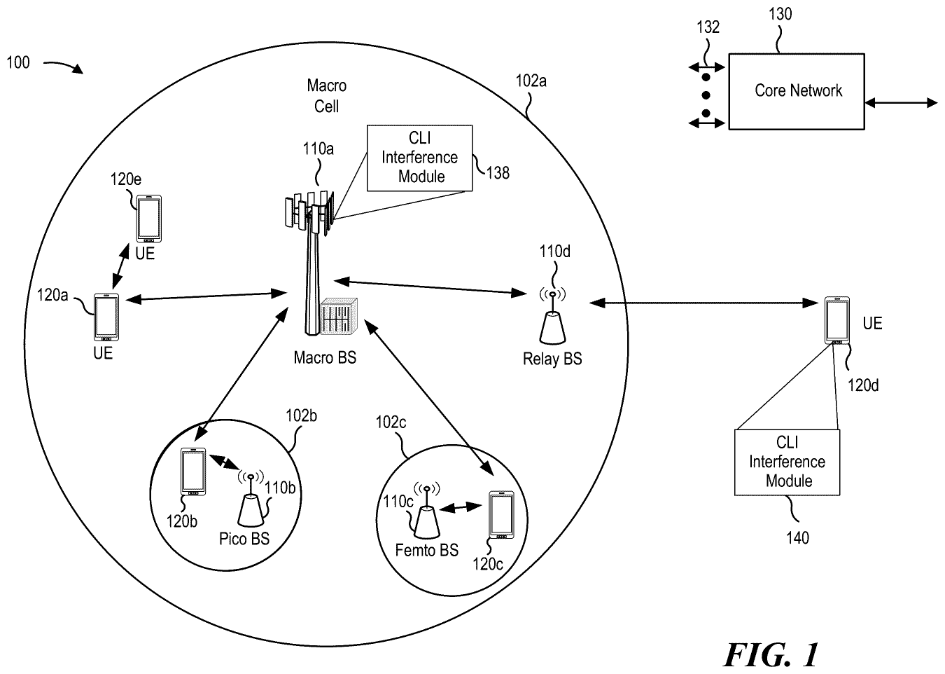

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a CLI interference module 140. For brevity, only one UE 120d is shown as including the CLI interference module 140. The CLI interference module 140 may receive downlink signals from a network device. The CLI interference module 140 may also process cross-link interference (CLI) to the downlink signals, the cross-link interference originating from a second UE. The CLI interference module 140 may further receive a configuration for a report of multiple differential cross-link interference metric values measured for multiple different cross-link interference resources and an absolute cross-link interference metric value measured for the different CLI resources. The CLI interference module 140 may also transmit the report of the differential cross-link interference metric values measured for the different CLI resources.

The core network 130 or the base stations 110 may include a CLI interference module 138. For brevity, only one base station 110a is shown as including the CLI interference module 138. The CLI interference module 138 may transmit downlink signals to a first user equipment (UE). The CLI interference module 138 may also configure the first UE with a multiple cross-link interference (CLI) resources. The CLI interference module 138 may further configure the first UE with a report of multiple differential cross-link interference metric values measured for multiple different cross-link interference resources and an absolute cross-link interference metric value measured for the different CLI resources. The CLI interference module 138 may receive, from the first UE, the report of the differential cross-link interference metric values measured for the CLI resources.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

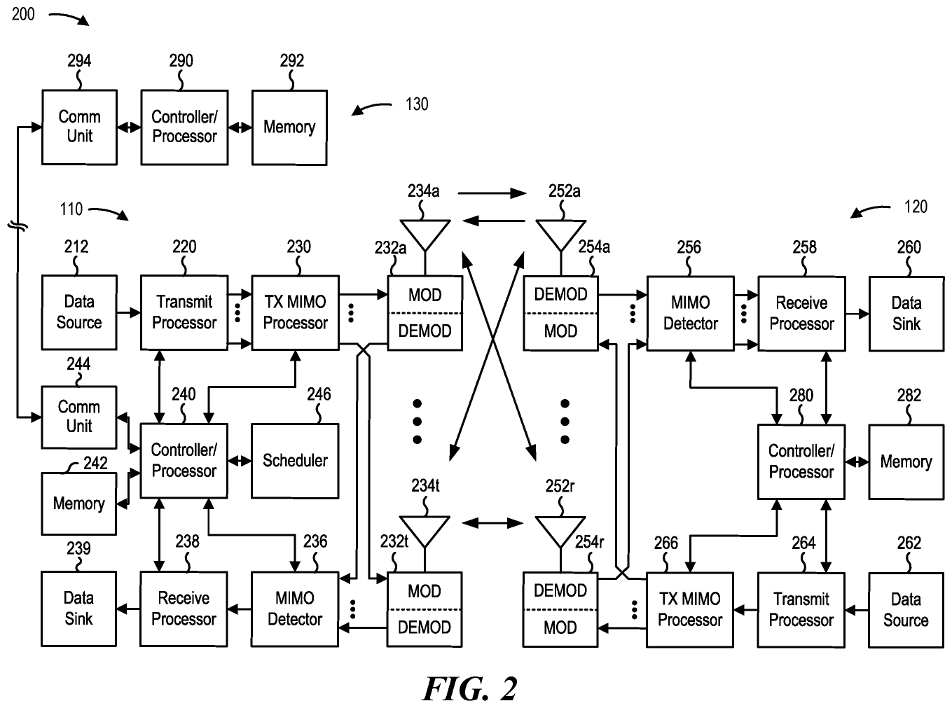

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

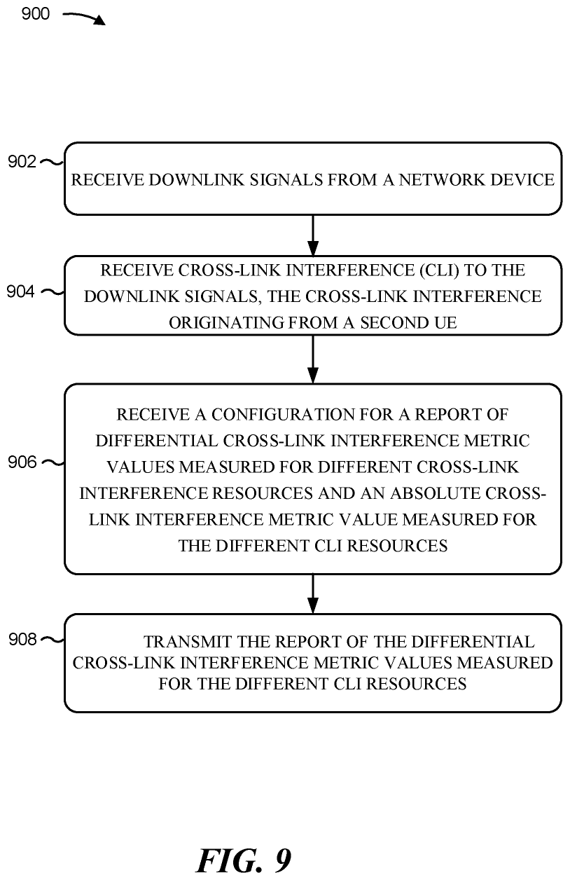

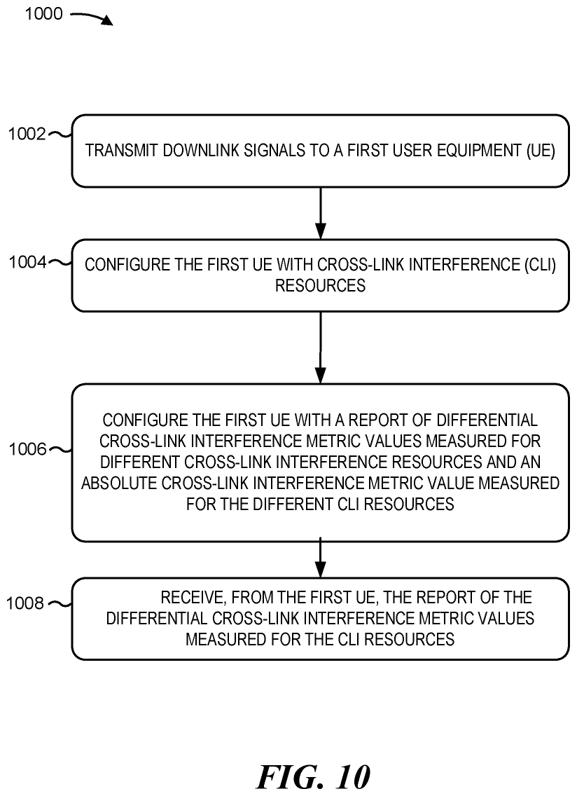

The controller/processor 240 of the base station 110, the controller/processor 280 of the UE 120, and/or any other component(s) of FIG. 2 may perform one or more techniques associated with differential cross-link interference reporting, as described in more detail elsewhere. For example, the controller/processor 240 of the base station 110, the controller/processor 280 of the UE 120, and/or any other component(s) of FIG. 2 may perform or direct operations of, for example, the processes of FIGS. 9 and 10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for transmitting, and/or means for configuring. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

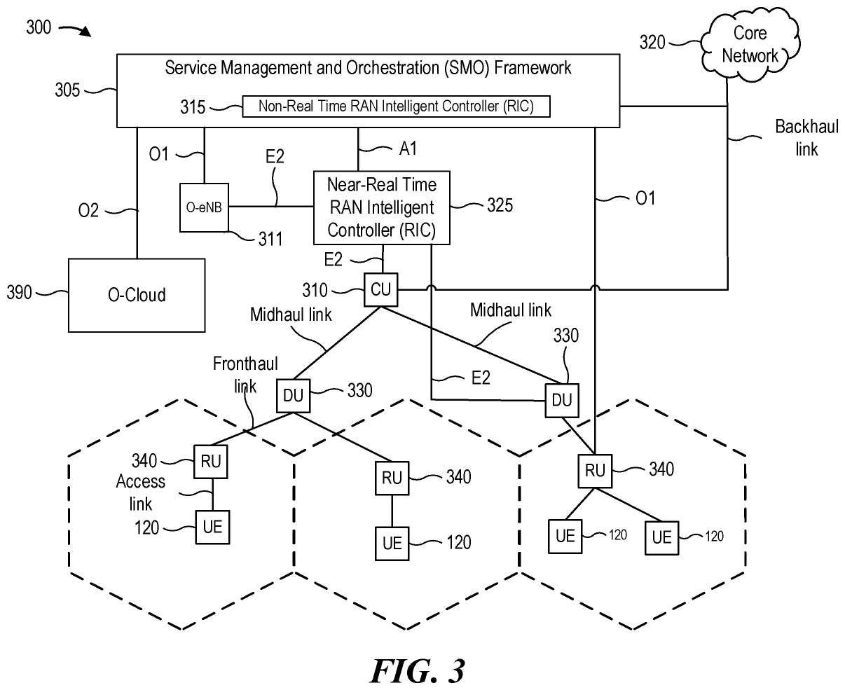

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) X11, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the Non-RT RIC 315 or the near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

Currently, devices generally communicate in a half duplex mode where the devices either transmit a signal or receive a signal at one time. Full duplex communication allows simultaneous transmission and reception. Thus, full duplex communication has the potential to increase throughput for both a base station and a UE.

Full duplex communication, such as simultaneous uplink and downlink transmission, may occur in various frequency bands, such as frequency range two (FR2). Full duplex capability can be present at one or both of the base station or the UE. For instance, at the UE, uplink transmission can originate from one panel and downlink reception can occur in another panel. Alternatively, at the base station, uplink transmission can originate from one panel and downlink reception can occur in another panel. Full duplex capability is conditional on beam separation, self-interference between downlink and uplink, clutter echo, etc. If these conditions are not satisfied, full duplex mode may be disabled. Benefits of full duplex communication include latency reduction. For example, it may be possible to receive downlink signals in uplink only slots, which can reduce latency. Other benefits include per cell or per UE spectrum efficiency enhancement, more efficient resource utilization, and coverage enhancement.

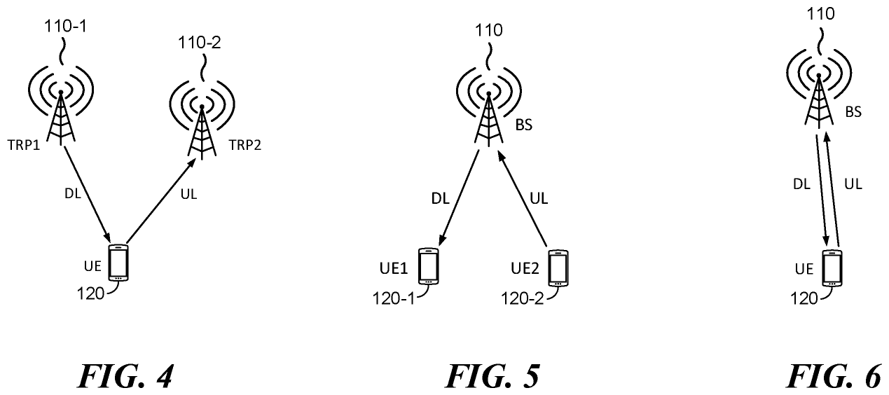

FIG. 4 is a block diagram illustrating a first example full duplex use case, in accordance with aspects of the present disclosure. In the example of FIG. 4, a full duplex UE 120 simultaneously communicates on the downlink (DL) with a first half-duplex base station (transmit and receive point (TRP1)) 110-1 and on the uplink (UL) with a second half-duplex bases station (TRP2) 110-2.

FIG. 5 is a block diagram illustrating a second example full duplex use case, in accordance with aspects of the present disclosure. In the example of FIG. 5, a full duplex base station 110 simultaneously communicates on the downlink with a first half-duplex UE 120-1 and on the uplink with a second half-duplex UE 120-2.

FIG. 6 is a block diagram illustrating a third example full duplex use case, in accordance with aspects of the present disclosure. In the example of FIG. 6, a full duplex UE 120 simultaneously communicates on the uplink and the downlink with a full duplex base station 110.

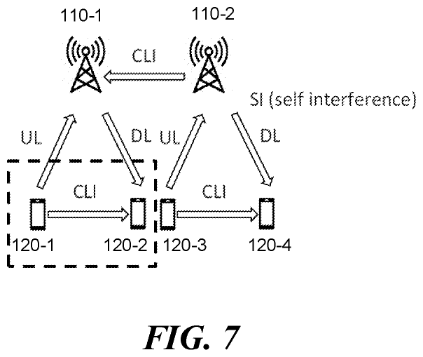

Referring to the first use case shown in FIG. 4 with full duplex base stations and a half-duplex UE, a deployment scenario is now described with reference to FIG. 7. FIG. 7 is a block diagram illustrating an example deployment scenario, in accordance with aspects of the present disclosure. In the example of FIG. 7, full duplex base stations 110-1, 110-2 communicate with half-duplex UEs 120-1, 120-2, 120-3, 120-4. Cross-link interference (CLI) may result from this deployment. For example, the uplink transmissions from a first UE 120-1 may interfere with downlink communications received at a nearby second UE 120-2. Similarly, the uplink transmissions from a third UE 120-3 may interfere with downlink communications received at a fourth UE 120-4. There may also be cross-link interference among the base stations 110-1, 110-2. In the example of FIG. 7, a second base station 110-2 interferes with communication at a first base station 110-1. Self-interference (SI) may also be present at the second base station 110-2.

In 3GPP Release 16, for inter-UE cross-link interference reporting, one cross-link interference metric is reported for each cross-link interference resource. In the case of full duplex frequency division multiplexed (FDM) communications from a base station, cross-link interference leaking from uplink bandwidth (BW) can vary across downlink subbands (SB). Separate cross-link interference resources may need to be configured for each downlink subband to measure the leaked cross-link interference. Cross-link interference has various levels of impact from subband to subband. A differential or delta cross-link interference report across subbands may be used to reduce report overhead. Cross-link interference may also have various levels of impact from cross-link interference resource to cross-link interference resource in the time domain. In other words, the interference may vary at different times. In this case, a differential or delta cross-link interference report across different cross-link interference time resources may be used to reduce report overhead as well. According to aspects of the present disclosure, a differential inter-UE cross-link interference report can be used among multiple reported cross-link interference values. The differential report may be for each cross-link interference resource, such as a subband or time occasion (e.g., slot or symbol).

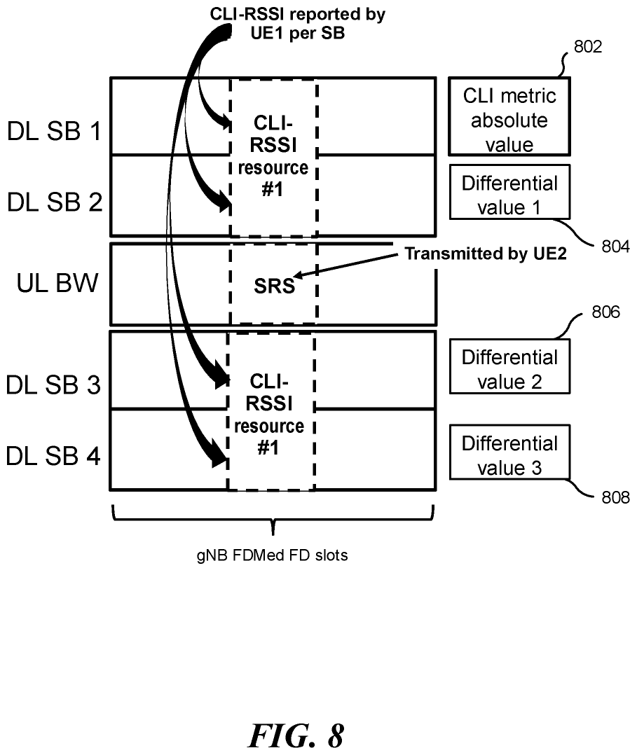

FIG. 8 is a block diagram illustrating an example cross-link interference report, in accordance with aspects of the present disclosure. In the example of FIG. 8, a full duplex base station communicates with two UEs, similar to the example shown in FIG. 7. A second UE, UE 2, transmits a sounding reference signal (SRS) to the base station with uplink bandwidth. A first UE, UE 1, receives downlink transmissions from the base station via downlink (DL) subbands, SB 1, SB 2, SB 3, SB 4. As seen in FIG. 8, the uplink and downlink communications are frequency division multiplexed (FDM'ed) in full duplex (FD) slots of the base station (e.g., gNB).

In the example of FIG. 8, the uplink transmission from the second UE, UE 2, interferes with the downlink communications on the downlink subbands, SB 1, SB 2, SB 3, SB 4. The amount of interference experienced on each subband may be different. For example, the cross-link interference to subband 2 and subband 3 may be stronger than the cross-link interference to subband 1 and subband 4.

According to aspects of the present disclosure, a UE may report differential cross-link interference metric values. The reporting may be based on a configuration received from a base station. In some aspects, the UE measures the values on different subbands (as seen in FIG. 8). In other aspects, the UE measures the values on different cross-link interference time resources. A wideband cross-link interference resource can be configured for multiple subbands, or individual cross-link interference resources may be configured for each subband.

In the example of FIG. 8, a wideband resource, cross-link interference received signal strength indicator (CLI-RSSI) resource #1, is configured to report the cross-link interference (CLI) received signal strength indicator (RSSI) value for different subbands. The UE reports a cross-link interference metric absolute value 802 for the first subband, SB 1. The UE also reports differential values 804, 806, 808 for the remaining subbands, SB 2, SB 3, SB 4. The differential values 804, 806, 808 may be relative to the absolute value 802. Although FIG. 8 illustrates a subband report, the different resources can be on a same band (e.g., wideband) but differential on different symbols or slots. In some aspects, the differential report is a layer one (L1) report. In other aspects, the differential report is a layer three (L3) report.

Different options to report differential cross-link interference metric values are now described.

In a first option, a receiver UE reports the absolute cross-link interference metric value for the resource (e.g., subband) experiencing the strongest interference, in other words, the worst resource for transmission purposes. The UE then reports differential cross-link interference metric delta values on all other resources (e.g., subbands). The delta values are treated as negative delta values in the first option. In some aspects, the report includes a field to indicate which cross-link interference resource identifier (ID) (e.g., subband 1) experiences the strongest interference. The report may also include a second field for the absolute strongest value (e.g., 25 dB). Additional fields indicate remaining delta values, e.g., in sequential order while skipping the resource (e.g., subband) experiencing the strongest interference. In the example of FIG. 8, the strongest cross-link interference is experienced on SB 1. The report then sequentially lists the remaining subbands, in this example, SB 2, SB 3, and SB 4. If the strongest cross-link interference was experienced on SB 2, the remaining subbands would be listed as SB 1, SB 3, and SB 4, that is, skipping SB 2.

In a second option, a receiver UE reports the absolute cross-link interference metric value for the resource (e.g., subband) experiencing the weakest interference, in other words, the best resource for transmission. The UE then reports differential cross-link interference metric delta values on all other resources (e.g., subbands). The delta values are treated as positive delta values in the second option. In some aspects, the report also includes a field to indicate which cross-link interference resource ID (e.g., subband ID) experiences the weakest interference. The report may also include a second field for the absolute weakest value. Additional fields indicate remaining delta values, e.g., in sequential order while skipping the best resource.

In a third option, a receiver UE reports resource(s) (e.g., subband(s)) experiencing cross-link interference that is greater than or equal to a threshold. This option contrasts with other options that report all remaining resources. In this third option, the UE reports the absolute cross-link interference metric value for the resource experiencing the strongest interference. The UE then reports differential cross-link interference delta metric values for the rest of the resources experiencing cross-link interference above the threshold level. The report may also include fields to indicate an ID of the resource experiencing the strongest cross-link interference and a corresponding absolute value. The report may also include fields for the remaining delta values, e.g., in sequential order while skipping the weakest resource. The report may also include the ID of each of the remaining resources along with the corresponding delta value. The ID may be included in this option because not all resources are indicated in the report (only those with cross-link interference exceeding the threshold). In some aspects, a base station configures the threshold.

In a fourth option, a receiver UE reports the resource(s) (e.g., subband(s)) experiencing cross-link interference that is below a threshold. In this fourth option, the UE reports the absolute cross-link interference metric value for the resource experiencing the weakest interference. The UE then reports differential cross-link interference delta metric values for the rest of the resources experiencing cross-link interference below the threshold level. The report may also include fields to indicate the ID of the resource experiencing the weakest cross-link interference and a corresponding absolute value. The report may also include fields for the remaining delta values, e.g., in sequential order while skipping the weakest resource. The report may also include the ID of each of the remaining resources along with the corresponding delta value.

In a fifth option, a base station may configure the UE to report the top X (e.g., top 5) strongest or weakest cross-link interference differential values. In the fifth option, the report may include fields to indicate the strongest or weakest resource ID and corresponding absolute value. The report may also include fields for the remaining top X-1 delta values, e.g., in sequential order while skipping the strongest or weakest resource. The report may also include the ID of each of the remaining resources along with the corresponding delta value.

As indicated above, FIGS. 4-8 are provided as examples. Other examples may differ from what is described with respect to FIGS. 4-8.

FIG. 9 is a flow diagram illustrating an example process 900 performed, for example, by a user equipment (UE), in accordance with various aspects of the present disclosure. The example process 900 is an example of differential inter-user equipment (UE) cross-link interference (CLI) reporting. The operations of the process 900 may be implemented by a UE 120.

At block 902, the user equipment (UE) receives downlink signals from a network device. For example, the UE (e.g. using the antenna 252, DEMOD/MOD 254, MIMO detector 256, receive processor 258, controller/processor 280, and/or memory 282) may receive the downlink signals. In some aspects, the network device communicates in a full duplex mode.

At block 904, the user equipment (UE) receives cross-link interference (CLI) to the downlink signals, the cross-link interference originating from a second UE. For example, the UE (e.g. using the antenna 252, DEMOD/MOD 254, MIMO detector 256, receive processor 258, controller/processor 280, and/or memory 282) may receive the CLI to the downlink signals. The second UE may transmits uplink signals to the network device simultaneously with the first UE receiving the downlink signals

At block 906, the user equipment (UE) receives a configuration for a report of multiple differential cross-link interference metric values measured for multiple different cross-link interference resources and an absolute cross-link interference metric value measured for the different CLI resources. For example, the UE (e.g. using the antenna 252, DEMOD/MOD 254, MIMO detector 256, receive processor 258, controller/processor 280, and/or memory 282) may receive the configuration. In some aspects, the report indicates the absolute cross-link interference metric value for a particular resource, and differential cross-link interference metric values for additional resources, relative to the absolute cross-link interference metric value. The differential cross-link interference metric values for the additional resources may be in sequential order while skipping the particular resource associated with the absolute cross-link interference metric value. The resource may be a wideband resource including multiple subbands, an individual per subband resource, or a slot or symbol resource.

At block 908, the user equipment (UE) transmits the report of the differential cross-link interference metric values measured for the different CLI resources. For example, the UE (e.g. using the antenna 252, DEMOD/MOD 254, TX MIMO processor 266, transmit processor 264, controller/processor 280, and/or memory 282) may transmit the report. The report may be a layer one or layer three report.

FIG. 10 is a flow diagram illustrating an example process 1000 performed, for example, by a network device, in accordance with various aspects of the present disclosure. The example process 1000 is an example of differential inter-user equipment (UE) cross-link interference (CLI) reporting. The operations of the process 900 may be implemented by a network device 130 and/or base station 110.

At block 1002, the network device and/or base station transmits downlink signals to a first user equipment (UE). For example, the UE (e.g. using the antenna 234, MOD/DEMOD 232, TX MIMO processor 230, transmit processor 220, controller/processor 240, and/or memory 242) may transmit the downlink signals. The network device may operate in full duplex mode to also simultaneously receive transmissions from another UE.

At block 1004, the network device and/or base station configures the first UE with cross-link interference (CLI) resources. For example, the UE (e.g. using the controller/processor 240, and/or memory 242) may configure the first UE. The resources may be wideband resources including multiple subbands, individual per subband resources, or a slot or symbol resources.

At block 1006, the network device and/or base station configures the first UE with a report of differential cross-link interference metric values measured for different cross-link interference resources and an absolute cross-link interference metric value measured for the different CLI resources. For example, the UE (e.g. using the controller/processor 240, and/or memory 242) may configure the first UE. In some aspects, the report indicates the absolute cross-link interference metric value for a particular resource, and differential cross-link interference metric values for additional resources, relative to the absolute cross-link interference metric value. The differential cross-link interference metric values for the additional resources may be in sequential order while skipping the particular resource associated with the absolute cross-link interference metric value.

At block 1008, the network device and/or base station receives from the first UE, the report of the plurality of differential cross-link interference metric values measured for the CLI resources. For example, the UE (e.g. using the antenna 234, MOD/DEMOD 232, MIMO detector 236, receive processor 238, controller/processor 240, and/or memory 242) may receive the report. The report may be a layer one or layer three report.

### Example Aspects

Aspect 1: A method of wireless communication by a first user equipment (UE), comprising: receiving downlink signals from a network device; receiving cross- link interference (CLI) to the downlink signals, the cross-link interference originating from a second UE; receiving a configuration for a report of a plurality of differential cross-link interference metric values measured for a plurality of different cross-link interference resources and an absolute cross-link interference metric value measured for the plurality of different CLI resources; and transmitting the report of the plurality of differential cross-link interference metric values measured for the plurality of different CLI resources.

Aspect 2: The method of Aspect 1, in which the report indicates the absolute cross-link interference metric value for a particular resource, and differential cross-link interference metric values for additional resources, relative to the absolute cross-link interference metric value.

Aspect 3: The method of Aspect 1 or 2, in which the differential cross-link interference metric values for the additional resources are in sequential order while skipping the particular resource associated with the absolute cross-link interference metric value.

Aspect 4: The method of any of the preceding Aspects, in which the particular resource experiences a strongest level of cross-link interference.

Aspect 5: The method of any of the Aspects 1-3, in which the particular resource experiences a lowest level of cross-link interference.

Aspect 6: The method of any of the preceding Aspects, further comprising receiving, from the network device, a configuration for an absolute cross-link interference threshold, in which a level of cross-link interference experienced at each of the additional resources exceeds the absolute cross-link interference threshold, the particular resource experiences a strongest level of cross-link interference that exceeds the absolute cross-link interference threshold, and the report further includes an identifier (ID) for each additional resource.

Aspect 7: The method of any of the Aspects 1-5, further comprising receiving, from the network device, a configuration for an absolute cross-link interference threshold, in which a level of cross-link interference experienced at each of the additional resources is less than or equal to the absolute cross-link interference threshold, the particular resource experiences a weakest level of cross-link interference that is less than or equal to the absolute cross-link interference threshold, and the report further includes an identifier (ID) for each additional resource.

Aspect 8: The method of any of Aspects, 1-5, further comprising receiving, from the network device, a configuration for a number, N, of top strongest or weakest resources, in which the report indicates an absolute cross-link interference metric value for a strongest or weakest resource, an identifier (ID) of the strongest or weakest resource, differential cross-link interference metric values for additional N-1 resources, an ID for each N-1 additional resources, the additional resources comprising the top N-1 resources in sequential order while skipping the strongest or weakest resource associated with the absolute cross-link interference metric value.

Aspect 9: The method of any of the preceding Aspects, in which the resource is a wideband resource including a plurality of subbands.

Aspect 10: The method of any of the Aspects 1-8, in which the resource is an individual per subband resource.

Aspect 11: The method of any of the Aspects 1-8, in which the resource is a slot or symbol resource.

Aspect 12: The method of any of the preceding Aspects, in which the second UE transmits uplink signals to the network device simultaneously with the first UE receiving the downlink signals.

Aspect 13: The method of any of the preceding Aspects, in which the report is a layer one report.

Aspect 14: The method of any of the Aspects 1-12, in which the report is a layer three report.

Aspect 15: A method of wireless communication by a network device, comprising: transmitting downlink signals to a first user equipment (UE); configuring the first UE with a plurality of cross-link interference (CLI) resources; configuring the first UE with a report of a plurality of differential cross-link interference metric values measured for a plurality of different cross-link interference resources and an absolute cross-link interference metric value measured for the plurality of different CLI resources; and receiving, from the first UE, the report of the plurality of differential cross-link interference metric values measured for the plurality of CLI resources.

Aspect 16: The method of Aspect 15, in which the report indicates the absolute cross-link interference metric value for a particular resource, and differential cross-link interference metric values for additional resources, the differential cross-link interference metric values being relative to the absolute cross-link interference metric value.

Aspect 17: The method of Aspect 15 or 16, in which the differential cross-link interference metric values for additional resources are in sequential order while skipping the particular resource associated with the absolute cross-link interference metric value.

Aspect 18: The method of any of the Aspects 15-17, in which the particular resource experiences a strongest level of CLI interference.

Aspect 19: The method of any of the Aspects 15-17, in which the particular resource experiences a lowest level of CLI interference.

Aspect 20: The method of any of the Aspects 15-19, further comprising transmitting, to the first UE, a configuration for an absolute cross-link interference threshold, in which a level of cross-link interference experienced at each of the additional resources exceeds the absolute cross-link interference threshold, the particular resource experiences a strongest level of interference that exceeds the absolute cross-link interference threshold, and the report further includes an identifier (ID) for each additional resource.

Aspect 21: The method of any of the Aspects 15-19, further comprising transmitting, to the first UE, a configuration for an absolute cross-link interference threshold, in which a level of cross-link interference experienced at each of the additional resources is less than or equal to the absolute cross-link interference threshold, the particular resource experiences a weakest level of CLI interference that is less than or equal to the absolute cross-link interference threshold, and the report further includes an identifier (ID) for each additional resource.

Aspect 22: The method of any of the Aspects 15-19, further comprising transmitting, to the first UE, a configuration for a number, N, of top strongest or weakest resources, in which the report indicates an absolute cross-link interference metric value for a strongest or weakest resource, an identifier (ID) of the strongest or weakest resource, differential cross-link interference metric values for additional N-1 resources, an identifier (ID) for each N-1 additional resources, the additional resources comprising the top N-1 resources in sequential order while skipping the strongest or weakest resource associated with the absolute cross-link interference metric value.

Aspect 23: The method of any of the Aspects 15-22, in which the resource is a wideband resource corresponding to a plurality of subbands.

Aspect 24: The method of any of the Aspects 15-22, in which the resource is an individual per subband resource.

Aspect 25: The method of any of the Aspects 15-22, in which the resource is a slot or symbol resource.

Aspect 26: The method of any of the Aspects 15-25, further comprising simultaneously receiving uplink signals from a second UE, the uplink signals interfering with the downlink signals.

Aspect 27: The method of any of the Aspects 15-26, in which the report is a layer one report.

Aspect 28: The method of any of the Aspects 15-26, in which the report is a layer three report.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c- c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a first user equipment (UE), comprising:
receiving downlink signals from a network device;
receiving cross-link interference (CLI) to the downlink signals, the cross-link interference originating from a second UE;
receiving a configuration for a report of a plurality of differential cross-link interference metric values measured for a plurality of different cross-link interference resources and an absolute cross-link interference metric value measured for the plurality of different CLI resources; and
transmitting the report of the plurality of differential cross-link interference metric values measured for the plurality of different CLI resources.

2. The method of claim 1, in which the report indicates the absolute cross-link interference metric value for a particular resource, and differential cross-link interference metric values for additional resources, relative to the absolute cross-link interference metric value.

3. The method of claim 2, in which the differential cross-link interference metric values for the additional resources are in sequential order while skipping the particular resource associated with the absolute cross-link interference metric value.

4. The method of claim 2, in which the particular resource experiences a strongest level of cross-link interference.

5. The method of claim 2, in which the particular resource experiences a lowest level of cross-link interference.

6. The method of claim 2, further comprising receiving, from the network device, a configuration for an absolute cross-link interference threshold, in which a level of cross-link interference experienced at each of the additional resources exceeds the absolute cross-link interference threshold, the particular resource experiences a strongest level of cross-link interference that exceeds the absolute cross-link interference threshold, and the report further includes an identifier (ID) for each additional resource.

7. The method of claim 2, further comprising receiving, from the network device, a configuration for an absolute cross-link interference threshold, in which a level of cross-link interference experienced at each of the additional resources is less than or equal to the absolute cross-link interference threshold, the particular resource experiences a weakest level of cross-link interference that is less than or equal to the absolute cross-link interference threshold, and the report further includes an identifier (ID) for each additional resource.

8. The method of claim 1, further comprising receiving, from the network device, a configuration for a number, N, of top strongest or weakest resources, in which the report indicates an absolute cross-link interference metric value for a strongest or weakest resource, an identifier (ID) of the strongest or weakest resource, differential cross-link interference metric values for additional N-1 resources, an ID for each N-1 additional resources, the additional resources comprising the top N-1 resources in sequential order while skipping the strongest or weakest resource associated with the absolute cross-link interference metric value.

9. The method of claim 1, in which the resource is a wideband resource including a plurality of subbands.

10. The method of claim 1, in which the resource is an individual per subband resource.

11. The method of claim 1, in which the resource is a slot or symbol resource.

12. The method of claim 1, in which the second UE transmits uplink signals to the network device simultaneously with the first UE receiving the downlink signals.

13. The method of claim 1, in which the report is a layer one report.

14. The method of claim 1, in which the report is a layer three report.

15. A method of wireless communication by a network device, comprising:
transmitting downlink signals to a first user equipment (UE);
configuring the first UE with a plurality of cross-link interference (CLI) resources;
configuring the first UE with a report of a plurality of differential cross-link interference metric values measured for a plurality of different cross-link interference resources and an absolute cross-link interference metric value measured for the plurality of different CLI resources; and
receiving, from the first UE, the report of the plurality of differential cross-link interference metric values measured for the plurality of CLI resources.

16. The method of claim 15, in which the report indicates the absolute cross-link interference metric value for a particular resource, and differential cross-link interference metric values for additional resources, the differential cross-link interference metric values being relative to the absolute cross-link interference metric value.

17. The method of claim 16, in which the differential cross-link interference metric values for additional resources are in sequential order while skipping the particular resource associated with the absolute cross-link interference metric value.

18. The method of claim 16, in which the particular resource experiences a strongest level of CLI interference.

19. The method of claim 16, in which the particular resource experiences a lowest level of CLI interference.

20. The method of claim 16, further comprising transmitting, to the first UE, a configuration for an absolute cross-link interference threshold, in which a level of cross-link interference experienced at each of the additional resources exceeds the absolute cross-link interference threshold, the particular resource experiences a strongest level of interference that exceeds the absolute cross-link interference threshold, and the report further includes an identifier (ID) for each additional resource.

21. The method of claim 16, further comprising transmitting, to the first UE, a configuration for an absolute cross-link interference threshold, in which a level of cross-link interference experienced at each of the additional resources is less than or equal to the absolute cross-link interference threshold, the particular resource experiences a weakest level of CLI interference that is less than or equal to the absolute cross-link interference threshold, and the report further includes an identifier (ID) for each additional resource.

22. The method of claim 15, further comprising transmitting, to the first UE, a configuration for a number, N, of top strongest or weakest resources, in which the report indicates an absolute cross-link interference metric value for a strongest or weakest resource, an identifier (ID) of the strongest or weakest resource, differential cross-link interference metric values for additional N-1 resources, an identifier (ID) for each N-1 additional resources, the additional resources comprising the top N-1 resources in sequential order while skipping the strongest or weakest resource associated with the absolute cross-link interference metric value.

23. The method of claim 15, in which the resource is a wideband resource corresponding to a plurality of subbands.

24. The method of claim 15, in which the resource is an individual per subband resource.

25. The method of claim 15, in which the resource is a slot or symbol resource.

26. The method of claim 15, further comprising simultaneously receiving uplink signals from a second UE, the uplink signals interfering with the downlink signals.

27. The method of claim 15, in which the report is a layer one report.

28. The method of claim 15, in which the report is a layer three report.

29. An apparatus for wireless communication by a first user equipment (UE), comprising:
a memory; and
at least one processor coupled to the memory and configured:
to receive downlink signals from a network device;
to receive cross-link interference (CLI) to the downlink signals, the cross-link interference originating from a second UE;
to receive a configuration for a report of a plurality of differential cross-link interference metric values measured for a plurality of different cross link-interference resources and an absolute cross-link interference metric value measured for the plurality of different CLI resources; and
to transmit the report of the plurality of differential cross-link interference metric values measured for the plurality of different CLI resources.

30. An apparatus for wireless communication by a network device, comprising:
a memory; and
at least one processor coupled to the memory and configured:
to transmit downlink signals to a first user equipment (UE);
to configure the first UE with a plurality of cross-link interference (CLI) resources;
to configure the first UE with a report of a plurality of differential cross-link interference metric values measured for a plurality of different cross-link interference resources and an absolute cross-link interference metric value measured for the plurality of different CLI resources; and
to receive, from the first UE, the report of the plurality of differential cross-link interference metric values measured for the plurality of CLI resources.
